(19) United States
(12) Patent Application Publication
(10) Pub. No.: US 2012/0305152 A1
(43) Pub. Date: Dec. 6, 2012

(54) TIRE COVER ASSEMBLY AND TIRE STRUCTURE FOR SAME

(76) Inventor: Young-Il Son, Seoul (KR)

(21) Appl. No.: 13/578,690

(22) PCT Filed: Oct. 1, 2010
(86) PCT No.: PCT/KR2010/006725

§ 371 Date: Aug. 13, 2012

(30) Foreign Application Priority Data
Feb. 25, 2010 (KR) 10-2010-0017190

(51) Int. Cl. B60C 27/20

(52) U.S. Cl. 152/185; 152/208; 152/217

(57) ABSTRACT

The present invention relates to a tire cover assembly comprising: a main tire body having a circular outer circumference; a tire cover configured to cover the main tire body; a cover support protruding from a side surface of the main tire body so as to support the tire cover in a radial direction of the main tire body, and disposed overall in a circular shape around a center of the main tire body; and a coupling medium configured to couple the tire cover to the cover support.

### CROSS-REFERENCE TO RELATED APPLICATION

The present application claims a priority of Korean Patent Application No. 10-2010-0017190 filed on Feb. 25, 2010, and the disclosure of specification and drawings thereof is incorporated in the present application by reference in its entirety.

### FIELD OF THE INVENTION

The present invention relates to a tire cover assembly used for driving of vehicle, more particularly, a tire cover assembly for vehicle providing a tire protecting cover detachably mounted on the outside of tire and a tire structure thereof.

### DESCRIPTION OF RELATED ART

Commonly, for preventing slip of vehicle when it is driven on snow road or ice road, a method is widely used of previously fitting chains on the tire or mounting snow tire.

However, in the case of using the chains, there are shortcomings that the service life of tire is shortened due to load concentrated on contact portion between the chains and tire and since many areas of tire in which the chains are not positioned are kept in contact with road surface, occurrence of slip cannot be still avoided. Meanwhile, in the case of the snow tire, there are shortcomings that replacement operation is very cumbersome and much time is required for the replacement operation and also effect of prevention of slip is insignificant.

Alternatively, technologies relating to a tire cover protecting the tire and having a anti-slip function are disclosed in Korean Published Utility Model No. 1988-9706, Korean Published Utility Model No. 1989-0004726 and Korean Published Patent Application No. 1999-0046007 etc.

In particular, Korean Published Utility Model No. 1988-9706 discloses a tire cover joined with concavo-convex part of outer surface of the tire. However, this tire cover can be used only for dedicated tire with concavo-convex pattern formed on the outer surface thereof, so has a shortcoming of poor universality.

Korean Published Utility Model No. 1989-0004726 discloses an anti-slip cover wherein cover body is formed of elastic rubber material, a plurality of fixing needles are embedded in inner surface of the cover body and a plurality of spikes are embedded in outer surface of the cover body. However, this anti-slip cover has shortcomings that the fixing needles formed in inner surface of the cover body have to be installed so as to get stuck in the outer surface of tire and mounting and disassembling operations are not easy since annular cover body has to be spread outward to be fitted on the tire.

Korean Published Patent Application No. 1999-0046007 discloses a tire cover having shoulder part and tread part surrounding the tire. However, this tire cover is also mounted on the tire by spreading outward annular cover body to fit it on the tire, so has a problem that mounting and disassembling operations are not easy. Furthermore, in the case where the tire cover is produced so as to sufficiently cover the side surface of tire, there is a shortcoming that an operation itself is impossible of spreading the tire cover to mount it on the tire.

### SUMMARY OF THE PRESENT INVENTION

The present invention has been devised considering the above-mentioned problems, and its object is to provide a tire cover assembly having a tire structure where formed in a main tire body is a structure which can support the tire cover so as to allow stable mounting of the tire cover.

Another object of the present invention is to provide a tire cover assembly having a structure enabling a strong coupling force to be kept between the main tire body and tire cover.

For achieving the above object, the present invention provides a tire cover assembly comprising a main tire body having a circular outer circumference; a tire cover covering the main tire body; a cover support protrudingly formed on side surface of the main tire body so as to support the tire cover in a radial direction of the main tire body and disposed so as to be circular on the whole around a center of the main tire body; and coupling means for coupling the tire cover with the cover support.

The coupling means may comprise a bolt for joining the tire cover with the cover support and a nut coupled with the bolt.

The coupling means further may comprise a spring coupled with the bolt to provide elastic force in a direction of pushing a head part of the bolt outward from the cover support.

The coupling means further comprises a first metal plate of ring or circular arc shape coupled with the tire cover; and a second metal plate of ring or circular arc shape corresponding to the first metal plate with the cover support interposed between the two metal plates, and it is preferred that the bolt extends through the cover support to connect the first and second metal plates with each other.

The tire cover has a flange-like edge end, and the first and second metal plates are positioned on both sides, respectively with the edge end of tire cover and the cover support interposed between the two metal plates, and the bolt may extend through the first and second metal plates to be coupled with the nut.

Alternatively, the first metal plate is positioned within a body of the tire cover to be coupled with the tire cover, and one end of the bolt may be secured to the first metal plate within the body of the tire cover.

The tire cover assembly according to the present invention may further comprise a bulletproof plate coupled with the cover support to cover the side surface of the main tire body.

Preferably, a reinforcing wire mesh may be inserted within the body of tire cover.

It is preferred that the tire cover has at least two cover units having a body in the form of arc and having such a length that the cover units are successively connected with one another to be in the form of circle on the whole; and coupling device for connecting the cover units with one another.

According to another aspect of the present invention, a tire structure is provided which comprises a main tire body having a circular outer circumference; and a cover support protrudingly formed on side surface of the main tire body so as to support a tire cover covering the main tire body in a radial direction of the main tire body and disposed so as to be circular on the whole around a center of the main tire body.

The cover support may be integrally formed with the main tire body.

According to the present invention, since the tire cover can be attached and detached to and from the cover support, replacement operation can be conveniently implemented when the tire cover is worn or damaged.

In the tire cover assembly according to the present invention, since the tire cover is supported by the cover support formed on the side surface of the tire, a problem can be prevented of the tire cover being impacted to a rim of tire wheel and then damaged due to centrifugal force resulting from high-speed rotation of the tire or decrease in air pressure of the tire.

Furthermore, coupling state between the tire cover and cover support can be stably kept by the metal plate of circular or circular arc shape provided in the coupling means and the spring.

### BRIEF DESCRIPTION OF THE DRAWINGS

The following drawings attached to the specification illustrate preferred examples of the present invention by example, and serve to enable technical concepts of the present invention to be further understood together with detailed description of the invention given below, and therefore the present invention should not be interpreted only with matters in such drawings.

FIG. 1 is a perspective view illustrating a tire structure according to an example of the present invention.

FIG. 2 is a sectional view taken along line A-A′ in FIG. 1.

FIG. 3 is a perspective view illustrating a modified example of FIG. 1.

FIG. 4 is a sectional view illustrating a tire structure according to another example of the present invention.

FIG. 5 is a coupled sectional view illustrating a tire cover assembly provided according to an example of the present invention.

FIGS. 6 and 7 are coupled sectional view illustrating a modified example of FIG. 5.

FIG. 8 is a side view illustrating coupling process for the tire cover assembly of FIG. 5.

FIG. 9 is a side view illustrating a tire cover assembly provided according to another example of the present invention.

FIG. 10 is a coupled sectional view of FIG. 9.

FIG. 11 is a side view illustrating a coupling structure of tire cover of assembled type which can be employed for the tire cover assembly according to the present invention.

FIG. 12 is a side view illustrating a situation where coupling has been completed in FIG. 11.

FIG. 13 is a sectional view taken along line B-B′ in FIG. 12.

FIG. 14 is a perspective view illustrating a coupling structure of cover units in FIG. 11.

FIG. 15 is a front view illustrating a modified example of concavo-convex member in FIG. 13.

FIGS. 16 to 18 are side views illustrating assembled structure of tire cover of assembled type which is employed for the tire cover assembly according to the present invention.

### DETAILED DESCRIPTION OF THE PRESENT INVENTION

Hereinafter, preferred examples of the present invention will be described in detail with reference to the attached drawings. Prior to detailed description, it should be noted that terms or words used in the specification and claims should not be limitedly interpreted as normal or lexical meanings, but should be interpreted as meanings and concepts coinciding to technical concepts of the present invention based on the principle that inventors may properly define the concepts of the terms in order to explain their inventions in a best way. Therefore, examples described in the specification and constructions illustrated in the drawings are only the most preferred example of the present invention, and do not represent all of the technical concepts of the present invention, and thus it should be understood that various equivalents and modifications may be present which can replace them at the time of application of the present invention.

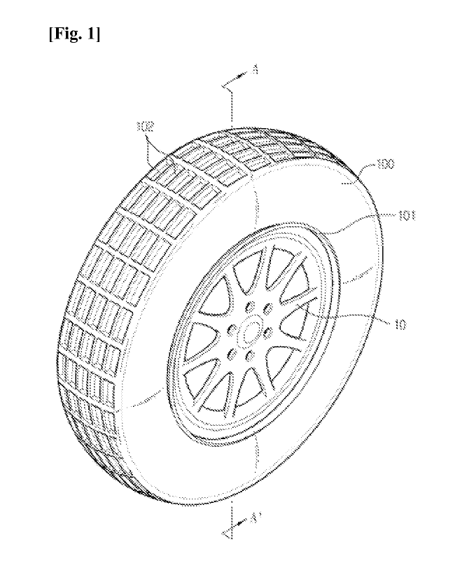

FIG. 1 is a perspective view illustrating a tire structure according to an example of the present invention, and FIG. 2 is a sectional view taken along line A-A′ in FIG. 1.

Referring to FIGS. 1 and 2, the tire structure according to an example of the present invention comprises a main tire body (100) mounted on a rim (11) of a tire wheel (10) and cover support (101) formed on both side surfaces of the main tire body (100).

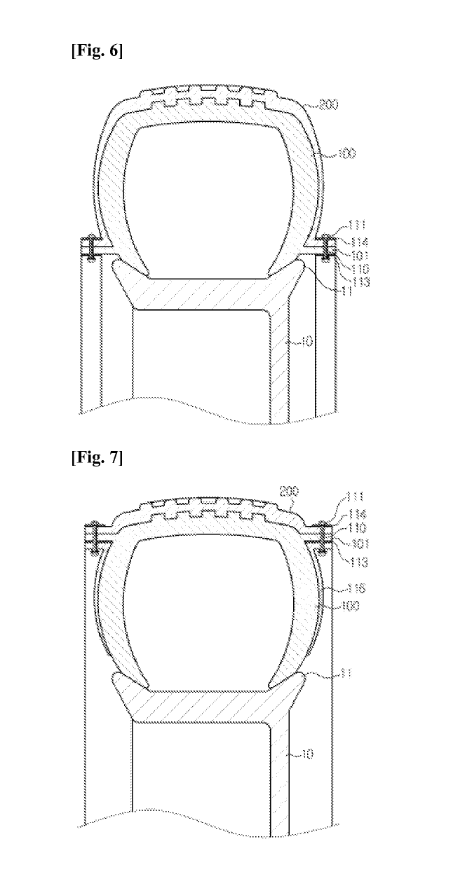

The main tire body (100) has a circular outer circumference, and an air tube (not shown) can be housed in inner accommodation space of the main tire body. Grooves (102) are repeatedly formed on the outer circumferential surface of the main tire body (100) in a predetermined pattern along circumferential direction and widthwise direction of the main tire body (100). When a tire cover (200) is coupled, protrusions formed on inner surface of the tire cover (refer to reference numeral “200” in FIG. 5) are fitted in the grooves (102) of the main tire body (100) to establish close coupling, whereby slip phenomenon between the main tire body (100) and tire cover (200) can be prevented.

The cover support (101) is intended to support edge ends of the tire cover (200) covering the main tire body (100) in a radial direction of the main tire body (100), and is protrudingly formed on the both side surfaces of main tire body (100). The cover support (101) has a structure wherein it extends outward from the side surface of the main tire body (100). The cover support (101) has a function of preventing the tire cover (200) from being impacted to the rim (11) of the tire wheel (10) and then damaged due to centrifugal force resulting from high-speed rotation of the tire or decrease in air pressure of the tire.

Preferably, the cover support (101) may be integrally formed with the main tire body (100), but of course, the present invention is not limited to such an example.

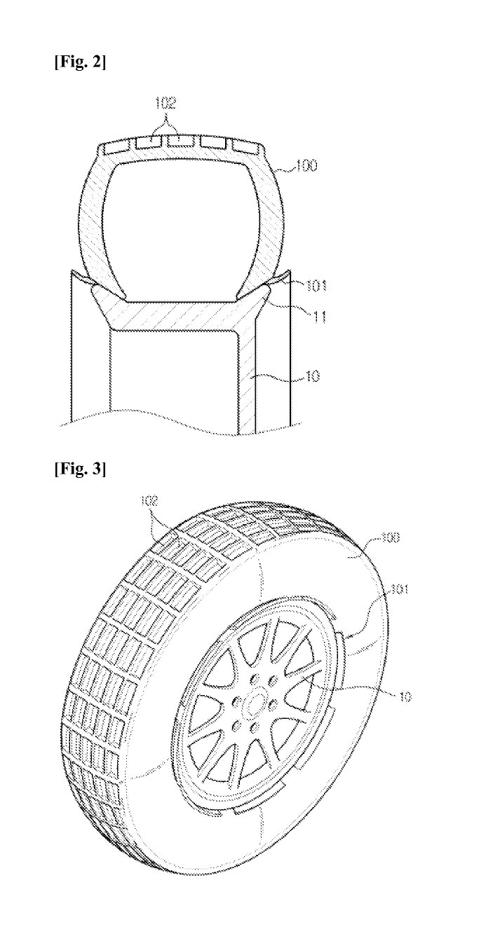

The cover support (101) is arranged so as to be circular on the whole around a center of the main tire body (100). In this connection, the cover support (101) may be formed by a flange structure of continuous ring shape, or as illustrated in FIG. 3, by a plurality of segments.

The diameter of cover support (101) is designed to be at least larger than that of the tire wheel (10) and smaller than the diameter of the main tire body (100). Although the cover support (101) is inclined in such way that its end portion is oriented upward as illustrated in FIGS. 1 and 2, it goes without saying that the present invention is not limited to such an example.

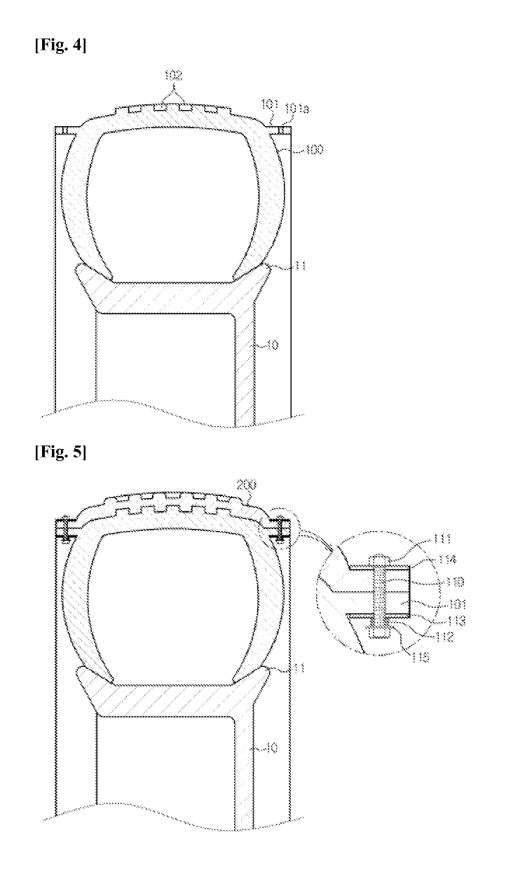

FIG. 4 is a sectional view illustrating a structure of tire according to another example of the present invention. As shown in the figure, the structure of tire according to another example of the present invention comprises a main tire body (100) and a cover support (101) positioned on side surface of the main tire body (100) and formed with coupling holes (101a) for coupling of a tire cover (200).

The cover support (101) is protruded from both side surfaces of the main tire body (100), and preferably is formed so as to extend in a direction parallel with a direction of central axis of the main tire body (100). Like the previously described example, the cover support (101) may be formed in the form of continuous ring along the circumferential direction of the main tire body (100) or by a plurality of segments.

FIG. 5 illustrates a tire cover assembly wherein the tire cover (200) is coupled with the main tire body (100) of FIG. 4.

Referring to FIG. 5, the tire cover assembly according to the present invention has a structure wherein the main tire body (100) is covered by the tire cover (200) and both edge ends of the tire cover (200) is coupled on the cover support (101) by means of coupling means.

The tire cover (200) covers the outer circumferential surface and both side surfaces of the main tire body (100) to thereby protect the main tire body (100) and the inside thereof. Employed as material for the tire cover (200) may be rubber and also material having mechanical strength, wear resistance and impact resistance such as rubber, iron core-embedded rubber, urethane, metal etc.

The edge end of the tire cover (200) and cover support (101) may be formed at locations near the rim (11) of the tire wheel (10) so as to sufficiently cover the side surface of the main tire body (100), as illustrated in FIG. 6.

The coupling means comprises a bolt (110) passing through coupling hole (101a) of the cover support (101) and corresponding edge end of the tire cover (200), a nut (111) coupled with the bolt (110), a spring (112) coupled with the bolt (110) for imparting elastic force from the cover support (101) to the bolt (110), and a washer (115) interposed between a head part of the bolt (110) and spring (112).

The spring (112) provides elastic force in a direction of pushing the head part of the bolt (110) outward from the cover support (101), i.e., of separating the head part from the cover support. By means of the elastic force of the spring (112), the nut (111) and the edge end of the tire cover (200) positioned below the nut can be continually kept in strongly close contact with the cover support (101). Coil spring is preferably employed for the spring (112). In this case, the spring (112) is interposed between the cover support (101) and bolt (110), and the bolt (110) is inserted in hollow space inside the coil spring to extend through the edge end of the tire cover (200) and the cover support (101).

As illustrated in FIG. 7, arranged in the cover support (101) may be bulletproof plate (116) covering the side surface of the main tire body (100). The bulletproof plate (116) is formed from metallic material having a bulletproof function etc., and secured by coupling one side of the plate with the cover support (101) by means of the bolt (110).

A first metal plate (114) and second metal plate (113) are arranged over and under a flange-like edge end of the tire cover (200) and cover support (101) while corresponding to each other. At this point, the bolt (110) extends through both of the first metal plate (114) and second metal plate (113) to be coupled with the nut (111).

The first metal plate (114) and second metal plate (113) are plates of ring or circular arc shape positioned on both sides of the edge end of the tire cover (200) and cover support (101) and have a supporting function enabling the tire cover (200) to be stable close contact with the cover support (101). The first metal plate (114) and second metal plate (113) are preferably made from iron-based casting.

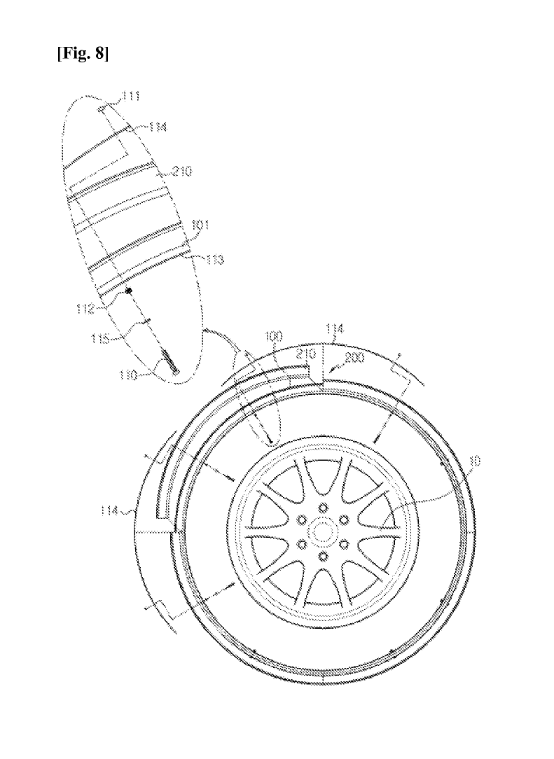

In the case of the tire cover (200) being of assembled type wherein it consists of a plurality of cover units (210) as illustrated in FIG. 8, for the sake of convenience of assembling operation, it is preferred that the second metal plate (113) positioned under the cover support (101) is formed in a ring shape and the first metal plate (114) coupled with the tire cover (200) is formed in a circular arc shape. At this point, the first metal plate (114) of circular arc shape may be positioned so as to extend over from a middle portion of one cover unit (210) to a middle portion of another cover unit (210) adjacent to the one cover unit. Alternatively, the first metal plate (114) may be positioned so as to correspond to each cover unit (210).

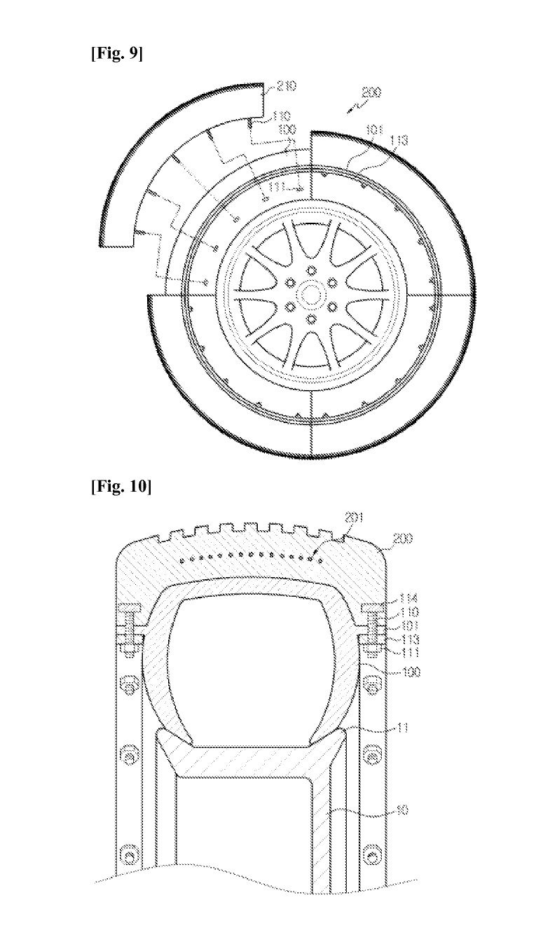

FIGS. 9 and 10 illustrate a construction of tire cover assembly provided according to another example of the present invention.

Referring to FIGS. 9 and 10, the tire cover assembly according to another example of the present invention has a structure wherein the first metal plate (114) is positioned within a body of the tire cover (200) to be coupled with the tire cover (200). One end of the bolt (110) for coupling the first metal plate (114) with the second metal plate (113) is secured to the first metal plate (114) within the body of the tire cover (200).

The structure as described above may be provided by joining the bolt (110) to the first metal plate (114) and thereafter carrying out extrusion process etc. to form the tire cover (200). In such a manufacturing process, it is preferred that a wire mesh (201) is additionally inserted within the body of the tire cover (200) to reinforce the tire cover (200).

According to the construction as described above, since the first metal plate (114) and bolt (110) are integrated with each of cover units (210) constituting the tire cover (200), operation of mounting the tire cover (200) can be conveniently implemented by joining each cover unit (210) so that the bolt (110) could extend through the cover support (101) and second metal plate (113) and thereafter tightening the nut (111).

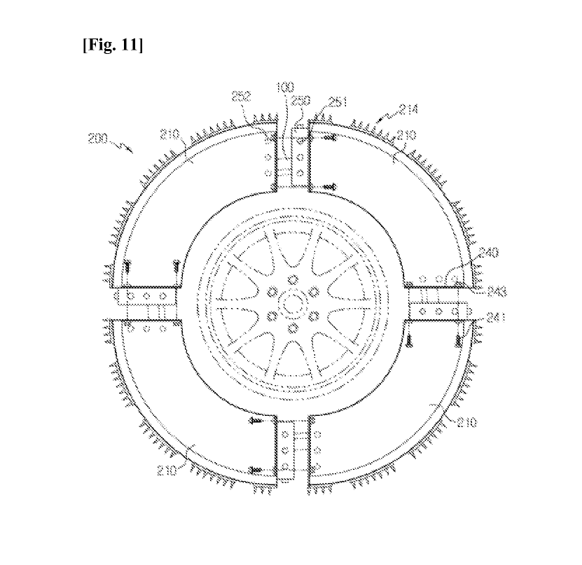

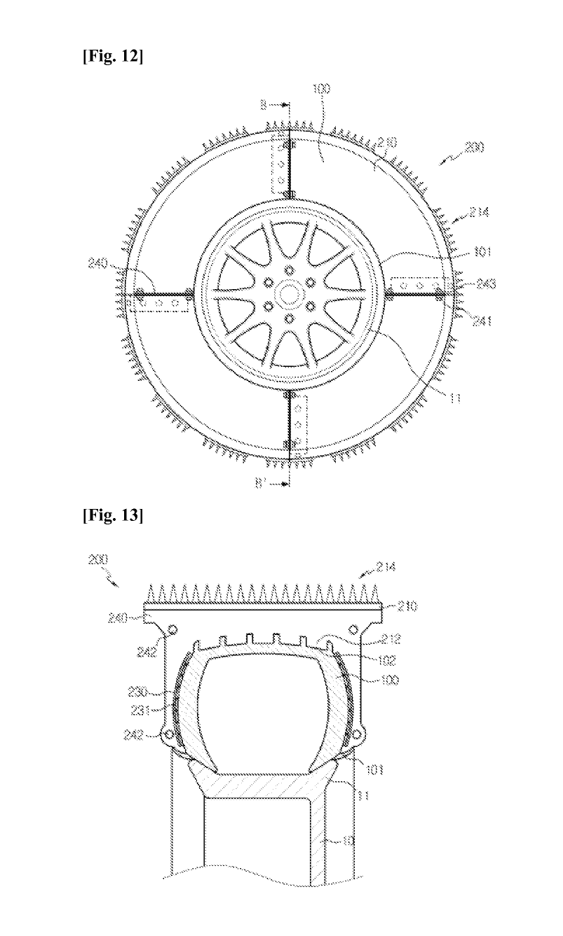

FIGS. 11 to 18 illustrate in detail a construction of tire cover of assembled type which can be employed for the tire cover assembly according to the present invention.

Referring to FIG. 11, the tire cover (200) comprises a plurality of cover units (210) divided from each other and coupling device coupling the cover units (210) with each other.

The cover unit (210) has a body having an accommodation space for surrounding the outer circumferential surface and two side surfaces of the main tire body (100) and curved in the form of arc along its longitudinal direction. If the plurality of cover units (210) are mounted on the main tire body (100) so as to be successively connected with one another, the tire cover (200) assuming a circular form as a whole is obtained as illustrated FIG. 12.

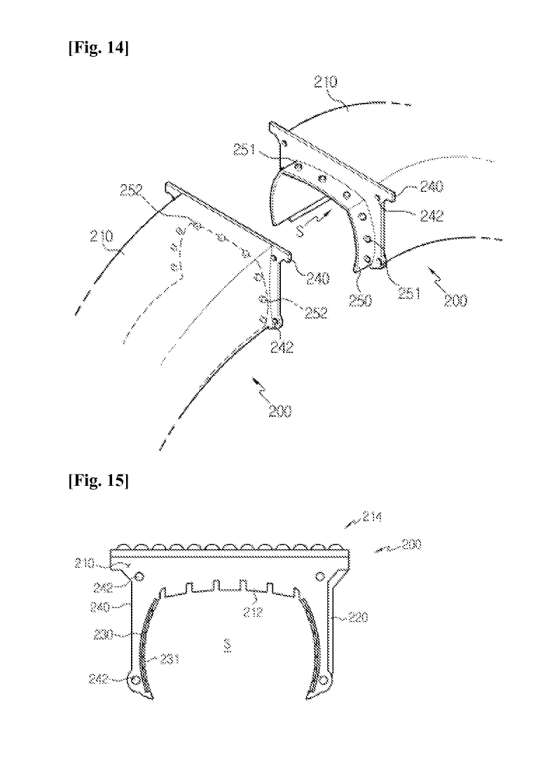

FIGS. 13 and 14 illustrate the construction of cove unit (210) in detail. As shown in the figures, the cover unit (210) has the accommodation space (S) in which the main tire body (100) is inserted, and concavo-convex member (214) having anti-slip function is formed on the outer surface of the cover unit contacting with ground surface.

Formed on inner surface of the cover unit (210) are protrusions (212) form-fitted with the grooves (102) formed on the outer surface of the main tire body (100). Accordingly, when the main tire body (100) is covered by the cover units (210), the protrusions (212) are fitted in the grooves (102) to establish close coupling, whereby slippage phenomenon between the main tire body (100) and tire cover (200) can be prevented.

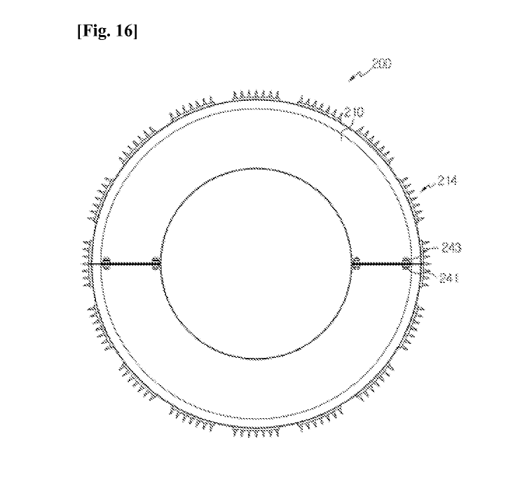

The concavo-convex member (214) is a part provided on the outer surface of the cover unit (210) and contacting with the ground surface, and includes concavo-convex pattern of various form providing anti-slip function. The concavo-convex of concavo-convex member (214) may be provided by a pattern of a plurality of spikes arranged with a constant interval, or as illustrated in FIG. 15 by a pattern of embossing allowing minimization of damage to the ground surface. Although not shown in drawings, the concavo-convex member (214) may be have caterpillar structure to thereby be effectively applied for the road surface of construction site where heavy equipment is used. Furthermore, in the case where the tire cover (200) having the concave-convex member (214) of caterpillar structure is used in common vehicles, wide contact area can be ensured between the tire cover (200) and road surface, thus a phenomenon can be prevented of the body of vehicle being leaned in one direction and accident can be prevented of the tire being caught in soft road surface such as snow road or muddy road.

In addition, the cover unit (210) is provided with a protective cover (220) covering outer side surface of the cover unit (210), which protects the main tire body (100) from impact exerted from the outside etc. In the case where a metal plate having a bulletproof function is employed for the protective cover (220), the tire cover (200) may be usefully applied for the tire of vehicles for use in military or guard.

Attached on both of inner side surfaces of the cover unit (210) are stretchable members (230) for example in the form of rubber plate, which have a function of enabling the cover unit (210) to be in firm close contact with the main tire body (100). That is to say, the stretchable members (230) are attached at location opposite the side surface of the main tire body (100) so as to be in close contact with the side surface of main tire body (100). It is preferred that a plurality of protrusions (231) are formed on such stretchable members (230) for increasing frictional force with the main tire body (100). Furthermore, although not illustrated in drawings, grooves may be formed on the outer side surface of main tire body (100) which are form-fitted with the protrusions (231) of the stretchable members (230).

For connecting the cover units (210) with one another, flange (240) with coupling hole (242) formed therein is formed at end portion of the cover units. Respective cover units (210) are connected by means of bolt (241) extending through the coupling hole (242) of the flange (240) and nut (243) coupled with the bolt (241).

Sleeve (250) with coupling protrusions (251) formed thereon is protruded from any one of both end portions of the cover unit (210), and coupling grooves (252) corresponding to the coupling protrusions (251) are formed in inner surface of the other end portion. With such a structure, in successively connecting the plurality of cover units (210), when the sleeve (250) of one cover unit (210) is inserted in adjacent cover unit (210), the coupling protrusions (251) are fitted into the coupling grooves (252), whereby close coupling can be achieved.

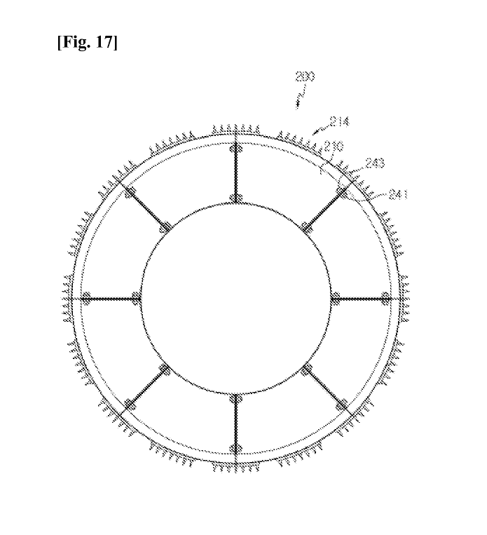

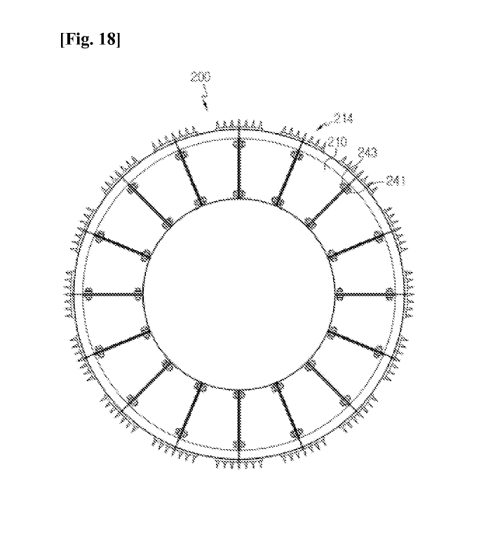

Entire circumference of the tire cover (200) is standardized to be an integer multiple of the length of each cover unit (210). With such a construction, the tire cover (200) conforming to characteristic of tires of various sizes can be conveniently designed by appropriately adjusting the number and arc length (or radius of curvature) of cover unit (210). That is to say, considering workability of assembly, stability, tension force etc., the tire cover (200) applied to the tires of small vehicles such as passenger cars use a few (for example, two) cover units (210) as illustrated in FIG. 16. However, the tire cover (200) applied to tires of large heavy equipment such as bucket loader or pay loader etc. preferably uses a plurality (for example, eight or sixteen) of cover units (210) as illustrated in FIGS. 17 and 18.

The tire cover (200) having the construction as described above is conveniently mounted on the main tire body (100) with operation of disposing the cover units (210) of the number corresponding to the size of relevant tire along the circumference of the tire on which the tire cover will be mounted and thereafter connecting the cover units (210) with one another by means of the bolt (241) and nut (243).

In coupling of the cover units (210), each cover unit (210) is seated on the main tire body (100) so as to completely surround the circumference of main tire body (100) and respective cover units (210) are pulled toward the center of main tire body (100) to be in close contact with one another, while the sleeve (250) of each cover unit (210) is inserted into the other end portion of adjacent cover unit (210) and thus the coupling protrusions (251) formed on the sleeve (250) are inserted in the coupling grooves (252). Furthermore, the edge ends of each cover unit (210) are secured to the cover support (101) formed on the side surfaces of the main tire body (100) by means of the bolt (110).

Then, if the bolt (241) and nut (243) are tightened at the flanges (240) of the cover units (210), the cover units (210) are successively connected while balance is kept on the whole, whereby one assembly completely surrounding the main tire body (100) is formed.

Meanwhile, if according to reverse order the bolt (241) and nut (243) are loosened and thereafter respective cover units (210) are separated from the main tire body (100), the tire cover (200) can be conveniently disassembled.

As above, although the present invention has been described using limited examples and drawings, the present invention is not limited to it, and various modifications and alterations may be naturally made by those having ordinary skills in the art within technical concepts and equivalents of claims described below of the present invention.

The present invention is applicable to common vehicles and also through diversification of the form of tire cover, naturally and usefully applicable to various vehicles for use in construction site or vehicles driven in environment where the condition of road surface is not good as in winter season etc.

Furthermore, since the side surface of tire can be protected by mounting the bulletproof plate on the cover support, the present invention may be usefully applicable to vehicles for military or guard requiring a bulletproof function.

According to the present invention, there are advantages that by only replacing the tire cover, the amount of waste tires generated can be remarkably reduced, so economical efficiency is shown of saving cost for disposing of the waste tires can be saved and environmental pollution can be reduced.

What is claimed:

1. A tire cover assembly, comprising a main tire body having a circular outer circumference; a tire cover covering the main tire body; a cover support protrudingly formed on side surface of the main tire body so as to support the tire cover in a radial direction of the main tire body and disposed so as to be circular on the whole around a center of the main tire body; and coupling means for coupling the tire cover with the cover support.

2. The tire cover assembly according to claim 1, wherein the cover support is integrally formed with the main tire body.

3. The tire cover assembly according to claim 1, wherein the coupling means comprises a bolt for joining the tire cover with the cover support and a nut coupled with the bolt.

4. The tire cover assembly according to claim 3, wherein the coupling means further comprises a spring coupled with the bolt to provide elastic force in a direction of pushing head part of the bolt outward from the cover support.

5. The tire cover assembly according to claim 3, wherein the coupling means further comprises a first metal plate of ring or circular-arc shape coupled with the tire cover; and a second metal plate of ring or circular-arc shape corresponding to the first metal plate with the cover support interposed between the two metal plates, and wherein the bolt extends through the cover support to connect the first and second metal plates with each other.

6. The tire cover assembly according to claim 5, wherein the tire cover has a flange-like edge end, and the first and second metal plates are positioned on both sides, respectively with the edge end of tire cover and the cover support interposed between the two metal plates, and the bolt extends through the first and second metal plates to be coupled with the nut.

7. The tire cover assembly according to claim 5, wherein the first metal plate is positioned within a body of the tire cover to be coupled with the tire cover, and one end of the bolt is secured to the first metal plate within the body of the tire cover.

8. The tire cover assembly according to claim 1, further comprising a bulletproof plate coupled with the cover support to cover the side surface of the main tire body.

9. The tire cover assembly according to claim 1, further comprising a reinforcing wire mesh inserted within the body of tire cover.

10. The tire cover assembly according to claim 1, wherein the tire cover has at least two cover units having a body in the form of arc and having such a length that the cover units are successively connected with one another to be in the form of circle on the whole; and coupling device for connecting the cover units with one another.

11. A tire structure, comprising a main tire body having a circular outer circumference; and a cover support protrudingly formed on side surface of the main tire body so as to support a tire cover covering the main tire body in a radial direction of the main tire body and disposed so as to be circular on the whole around a center of the main tire body.

12. The tire structure according to claim 11, wherein the cover support is integrally formed with the main tire body.
